(19) United States
(12) Patent Application Publication
(10) Pub. No.: US 2007/0222734 A1
(43) Pub. Date: Sep. 27, 2007

(54) Mobile device capable of receiving music or video content from satellite radio providers

(76) Inventor: Bao Q. Tran, San Jose, CA (US)

Correspondence Address: TRAN & ASSOCIATES, 6768 MEADOW VISTA CT., SAN JOSE, CA, 95135, US

(21) Appl. No.: 11/388,529

(22) Filed: Mar. 25, 2006

(51) Int. Cl. G09G 3/36

(52) U.S. Cl. 345/98

(57) ABSTRACT

Systems and methods are disclosed to play satellite radio music on a mobile phone by authenticating the mobile phone; generating a stream universal resource locator (URL) for a predetermined content; and receiving data from the stream URL and playing audio associated with the stream URL on the mobile phone.

### BACKGROUND

The present invention relates to a cell phone capable of playing satellite radio content or satellite video content.

Portable data processing devices such as cellular telephones have become ubiquitous due to the ease of use and the instant accessibility that the phones provide. For example, modern cellular phones provide calendar, contact, email, and Internet access functionalities that used to be provided by desktop computers. For providing typical telephone calling function, the cellular phone only needs a numerical keyboard and a small display. However, for advanced functionalities such as email or Internet access, full alphanumeric keyboards are desirable to enter text. Additionally, a large display is desirable for readability. However, such desirable features are at odds with the small size of the cellular phone.

Additionally, as the cellular phone takes over functions normally done by desktop computers, they carry sensitive data such as telephone directory, bank account and brokerage account information, credit card information, sensitive electronic mails (emails) and other personally identifiable information. The sensitive data needs to be properly secured. Yet, security and ease of use are requirements that are also at odds with each other.

### SUMMARY

In a first aspect, systems and methods are disclosed to play satellite radio music on a mobile phone by authenticating the mobile phone; generating a stream universal resource locator (URL) for a predetermined content; and receiving data from the stream URL and playing audio associated with the stream URL on the mobile phone.

In another aspect, a cell phone for playing satellite radio music includes a processor; a wireless cellular radio coupled to the processor; and code executing on the processor for authenticating the mobile phone; generating a stream universal resource locator (URL) for a predetermined content; and receiving data from the stream URL and playing audio associated with the stream URL on the mobile phone.

Implementations of the above aspects may include one or more of the following. The system can perform a search to identify the predetermined content. The search can include performing a taxonomy search for music. The search returns the stream address. The system can perform a federated search for the predetermined content. The system can sell items based on the search. The stream address can be a URL address, an MMS address, or an SMS address. The search can be formulated by the user using an SMS message or a WAP search query field.

In another aspect, a method provides communication for a portable data device by receiving and transmitting a cellular signal containing audio data; receiving a satellite signal containing one of: audio data, Internet protocol (IP) data; and outputting one of the audio data, Internet protocol data from the portable data device.

Implementations of the above aspect may include one or more of the following. The satellite signal can be one of: satellite digital radio service (SDARS), digital multimedia broadcast (DMB), digital audio broadcast (DAB), or digital video broadcast (DVB). The device can store audio video data for subsequent playing with a digital video recorder (DVR). The device can receive and play satellite radio transmissions. The user can browse the Internet using the satellite signal. The device can receive and render IP television (IPTV) data from the satellite signal. The device can also receive a terrestrial broadcast signal. The device can project a keyboard pattern using a light projector; capture one or more images of a user's digits on the keyboard pattern with a camera; and decode a character being typed on the keyboard pattern. The device can project video onto a surface.

In another aspect, an apparatus to provide communication for a portable data device includes a cellular transceiver to process a cellular signal containing audio data; a satellite receiver to receive a satellite signal containing one of: audio data, Internet protocol data; and a processor coupled to the cellular transceiver and the satellite receiver to output one of the audio data, Internet protocol data from the portable data device.

Implementations of the above aspect may include one or more of the following. The apparatus can have a light projector to project a keyboard pattern and a display screen; a camera to capture one or more images of a user's digits on the keyboard pattern; and a processor coupled to the light projector and the camera to decode a character being typed on the keyboard pattern and render the character on the display screen. The apparatus can receive satellite signal with one of: satellite digital radio service (SDARS), digital multimedia broadcast (DMB), digital audio broadcast (DAB), or digital video broadcast (DVB). A data storage device can store video recording of movies or television shows for subsequent playing of the video. The processor can access the Internet using the satellite signal. The processor can display IP television (IPTV) data from the satellite signal.

In another aspect, an apparatus to provide communication for a portable data device includes a cellular transceiver to process a cellular signal containing audio data; a terrestrial receiver to receive a terrestrial broadcast signal over a licensed channel including one of AM, FM, VHF or UHV channels, said broadcast signal containing one of: audio data, Internet protocol data; and a processor coupled to the cellular transceiver and the satellite receiver to output one of the audio data, Internet protocol data from the portable data device.

Implementations of the above aspect may include one or more of the following. The apparatus can have a light projector to project a keyboard pattern and a display screen; a camera to capture one or more images of a user's digits on the keyboard pattern; and a processor coupled to the light projector and the camera to decode a character being typed on the keyboard pattern and render the character on the display screen. The apparatus can receive satellite signal with one of: satellite digital radio service (SDARS), digital multimedia broadcast (DMB), digital audio broadcast (DAB), or digital video broadcast (DVB). A data storage device can store video recording of movies or television shows for subsequent playing of the video. The processor can access the Internet using the satellite signal. The processor can display IP television (IPTV) data from the satellite signal. The device can receive terrestrial broadcast signal in the form of high definition radio (HD Radio) such as Ibiquity signals.

Advantages of the system may include one or more of the following. The system provides major improvements in terms of capabilities of mobile networks. The system supports high performance mobile communications and computing and offers consumers and enterprises mobile computing and communications anytime, anywhere and enables new revenue generating/productivity enhancement opportunities. Further, in addition to enabling access to data anytime and anywhere, the equipment is easier and cheaper to deploy than wired systems. Besides improving the overall capacity, the system's broadband wireless features create new demand and usage patterns, which will in turn, drive the development and continuous evolution of services and infrastructure.

### BRIEF DESCRIPTION OF THE FIGURES

FIG. 1 shows an exemplary portable data processing device.

FIG. 2 shows an exemplary process for communicating with the device of FIG. 1.

FIG. 3 shows an exemplary cellular telephone embodiment.

FIG. 4 shows another exemplary cellular telephone embodiment with enhanced I/O.

FIG. 5 shows yet another exemplary cellular telephone with enhanced I/O.

FIG. 6A shows an exemplary set-up screen running on a cell-phone.

FIG. 6B shows an exemplary channel category selection user interface.

FIG. 6C shows an exemplary album graphic display.

FIG. 6D shows an exemplary channel selection user interface.

### DESCRIPTION

Now, the present invention is more specifically described with reference to accompanying drawings of various embodiments thereof, wherein similar constituent elements are designated by similar reference numerals.

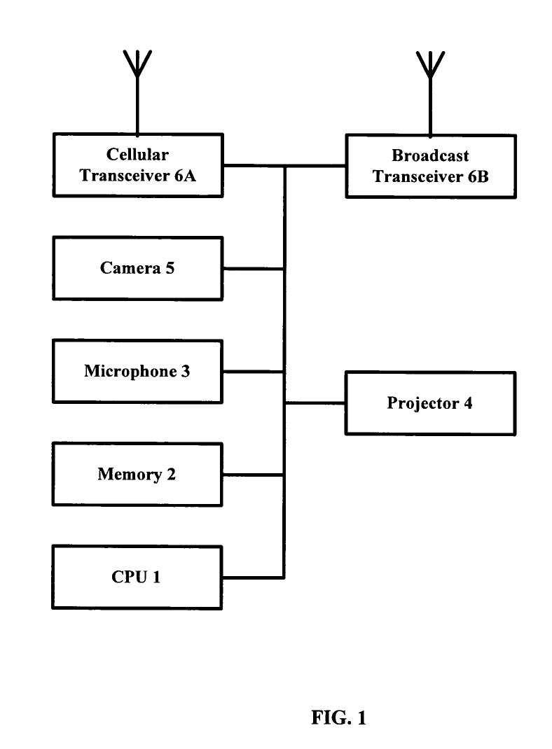

FIG. 1 shows an exemplary portable data-processing device having enhanced I/O peripherals. In one embodiment, the device has a processor 1 connected to a memory array 2 that can also serve as a solid state disk. The processor 1 is also connected to a light projector 4, a microphone 3 and a camera 5. A cellular transceiver 6A is connected to the processor 1 to access cellular network including data and voice. The cellular transceiver 6A can communicate with CDMA, GPRS, EDGE or 4G cellular networks. In addition, a broadcast transceiver 6B allows the device to receive satellite transmissions or terrestrial broadcast transmissions. The transceiver 6B supports voice or video transmissions as well as Internet access. Other alternative wireless transceiver can be used. For example, the wireless transceiver can be WiFi, WiMax, 802.X, Bluetooth, infra-red, cellular transceiver all, one or more, or any combination thereof.

In one implementation, the transceiver 6B can receive XM Radio signals or Sirius signals. XM Radio broadcasts digital channels of music, news, sports and children's programming direct to cars and homes via satellite and a repeater network, which supplements the satellite signal to ensure seamless transmission. The channels originate from XM's broadcast center and uplink to satellites or high altitude planes or balloons acting as satellites. These satellites transmit the signal across the entire continental United States. Each satellite provides 18 kw of total power making them the two most powerful commercial satellites, providing coast-to-coast coverage. Sirius is similar with 3 satellites to transmit digital radio signals. Sirius's satellite audio broadcasting systems include orbital constellations for providing high elevation angle coverage of audio broadcast signals from the constellation's satellites to fixed and mobile receivers within service areas located at geographical latitudes well removed from the equator.

In one implementation, the transceiver 6B receives Internet protocol packets over the digital radio transmission and the processor enables the user to browse the Internet at high speed. The user, through the device, makes a request for Internet access and the request is sent to a satellite. The satellite sends signals to a network operations center (NOC) who retrieves the requested information and then sends the retrieved information to the device using the satellite.

In another implementation, the transceiver 6B can receive terrestrial Digital Audio Broadcasting (DAB) signal that offers high quality of broadcasting over conventional AM and FM analog signals. In-Band-On-Channel (IBOC) DAB is a digital broadcasting scheme in which analog AM or FM signals are simulcast along with the DAB signal The digital audio signal is generally compressed such that a minimum data rate is required to convey the audio information with sufficiently high fidelity. In addition to radio broadcasts, the terrestrial systems can also support internet access. In one implementation, the transceiver 6B can receive signals that are compatible with the Ibiquity protocol.

In yet another embodiment, the transceiver 6B can receive Digital Video Broadcast (DVB) which is a standard based upon MPEG-2 video and audio. DVB covers how MPEG-2 signals are transmitted via satellite, cable and terrestrial broadcast channels along with how such items as system information and the program guide are transmitted. In addition to DVB-S, the satellite format of DVB, the transceiver can also work with DVB-T which is DVB/MPEG-2 over terrestrial transmitters and DVB-H which uses a terrestrial broadcast network and an IP back channel. DVB-H operates at the UHF band and uses time slicing to reduce power consumption. The system can also work with Digital Multimedia Broadcast (DMB) as well as terrestrial DMB.

In yet another implementation, Digital Video Recorder (DVR) software can store video content for subsequent review. The DVR puts TV on the user's schedule so the user can watch the content at any time. The DVR provides the power to pause video and do own instant replays. The user can fast forward or rewind recorded programs.

In another embodiment, the device allows the user to view IPTV over the air. Wireless IPTV (Internet Protocol Television) allows a digital television service to be delivered to subscribing consumers using the Internet Protocol over a wireless broadband connection. Advantages of IPTV include two-way capability lacked by traditional TV distribution technologies, as well as point-to-point distribution allowing each viewer to view individual broadcasts. This enables stream control (pause, wind/rewind etc.) and a free selection of programming much like its narrowband cousin, the web. The wireless service is often provided in conjunction with Video on Demand and may also include Internet services such as Web access and VOIP telephony, and data access (Broadband Wireless Triple Play). A set-top box application software running on the processor 210 and through cellular or wireless broadband internet access, can receive IPTV video streamed to the handheld device.

IPTV covers both live TV (multicasting) as well as stored video (Video on Demand VOD). Video content can be MPEG protocol. In one embodiment, MPEG2TS is delivered via IP Multicast. In another IPTV embodiment, the underlying protocols used for IPTV are IGMP version 2 for channel change signaling for live TV and RTSP for Video on Demand. In yet another embodiment, video is streamed using the H.264 protocol in lieu of the MPEG-2 protocol. H.264, or MPEG-4 Part 10, is a digital video codec standard, which is noted for achieving very high data compression. It was written by the ITU-T Video Coding Experts Group (VCEG) together with the ISO/IEC Moving Picture Experts Group (MPEG) as the product of a collective partnership effort known as the Joint Video Team (JVT). The ITU-T H.264 standard and the ISO/IEC MPEG-4 Part 10 standard (formally, ISO/IEC 14496-10) are technically identical, and the technology is also known as AVC, for Advanced Video Coding. H.264 is a name related to the ITU-T line of H.26x video standards, while AVC relates to the ISO/IEC MPEG side of the partnership project that completed the work on the standard, after earlier development done in the ITU-T as a project called H.26L. It is usual to call the standard as H.264/AVC (or AVC/H.264 or H.264/MPEG-4 AVC or MPEG-4/H.264 AVC) to emphasize the common heritage. H.264/AVC/MPEG-4 Part 10 contains features that allow it to compress video much more effectively than older standards and to provide more flexibility for application to a wide variety of network environments. H.264 can often perform radically better than MPEG-2 video-typically obtaining the same quality at half of the bit rate or less. Similar to MPEG-2, H.264/AVC requires encoding and decoding technology to prepare the video signal for transmission and then on the screen 230 or substitute screens (STB and TV/monitor, or PC). H.264/AVC can use transport technologies compatible with MPEG-2, simplifying an up-grade from MPEG-2 to H.264/AVC, while enabling transport over TCP/IP and wireless. H.264/AVC does not require the expensive, often proprietary encoding and decoding hardware that MPEG-2 depends on, making it faster and easier to deploy H.264/AVC solutions using standards-based processing systems, servers, and STBs. This also allows service providers to deliver content to devices for which MPEG-2 cannot be used, such as PDA and digital cell phones.

The H.264/AVC encoder system in the main office turns the raw video signals received from content providers into H.264/AVC video streams. The streams can be captured and stored on a video server at the headend, or sent to a video server at a regional or central office (CO), for video-on-demand services. The video data can also be sent as live programming over the network. Standard networking and switching equipment routes the video stream, encapsulating the stream in standard network transport protocols, such as ATM. A special part of H.264/AVC, called the Network Abstraction Layer (NAL), enables encapsulation of the stream for transmission over a TCP/IP network. When the video data reaches the handheld device through the transceiver 6B, the application software decodes the data using a plug-in for the client's video player (Real Player and Windows Media Player, among others).

In addition to the operating system and user selected applications, another application, a VOIP phone application executes on the processing unit or processor 1. Phone calls from the Internet directed toward the mobile device are detected by the mobile radio device and sent, in the form of an incoming call notification, to the phone device (executing on the processing unit 1). The phone device processes the incoming call notification by notifying the user by an audio output such as ringing. The user can answer the incoming call by tapping on a phone icon, or pressing a hard button designated or preprogrammed for answering a call. Outgoing calls are placed by a user by entering digits of the number to be dialed and pressing a call icon, for example. The dialed digits are sent to the mobile radio device along with instructions needed to configure the mobile radio device for an outgoing call using either the cellular transceiver 6A or the wireless broadcast transceiver 6B. If the call is occurring while the user is running another application such as video viewing, the other application is suspended until the call is completed. Alternatively, the user can view the video in mute mode while answering or making the phone call.

The light projector 4 includes a light source such as a white light emitting diode (LED) or a semiconductor laser device or an incandescent lamp emitting a beam of light through a focusing lens to be projected onto a viewing screen. The beam of light can reflect or go through an image forming device such as a liquid crystal display (LCD) so that the light source beams light through the LCD to be projected onto a viewing screen.

Alternatively, the light projector 4 can be a MEMS device. In one implementation, the MEMS device can be a digital micro-mirror device (DMD) available from Texas Instruments, Inc., among others. The DMD includes a large number of micro-mirrors arranged in a matrix on a silicon substrate, each micro-mirror being substantially of square having a side of about 16 microns.

Another MEMS device is the grating light valve (GLV). The GLV device consists of tiny reflective ribbons mounted over a silicon chip. The ribbons are suspended over the chip with a small air gap in between. When voltage is applied below a ribbon, the ribbon moves toward the chip by a fraction of the wavelength of the illuminating light and the deformed ribbons form a diffraction grating, and the various orders of light can be combined to form the pixel of an image. The GLV pixels are arranged in a vertical line that can be 1,080 pixels long, for example. Light from three lasers, one red, one green and one blue, shines on the GLV and is rapidly scanned across the display screen at a number of frames per second to form the image.

In one implementation, the light projector 4 and the camera 5 face opposite surfaces so that the camera 5 faces the user to capture user finger strokes during typing while the projector 4 projects a user interface responsive to the entry of data. In another implementation, the light projector 4 and the camera 5 on positioned on the same surface. In yet another implementation, the light projector 4 can provide light as a flash for the camera 5 in low light situations.

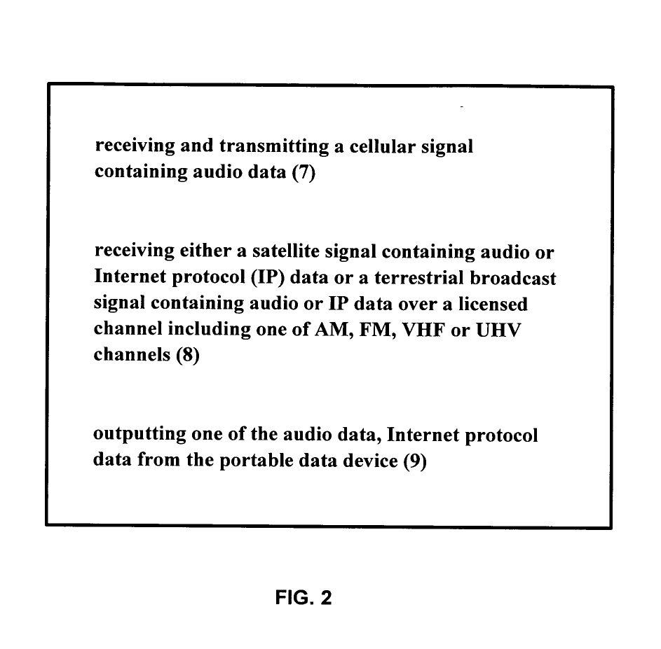

FIG. 2 shows an exemplary process executed by the system of FIG. 1. The system accesses the cellular transceiver 6A for receiving and transmitting a cellular signal containing audio data (7). The system also accesses the broadcast transceiver 6B for receiving either a satellite signal with audio data or Internet protocol (IP) data; or alternatively in the terrestrial transceiver implementation, the transceiver 6B can receive a terrestrial broadcast signal containing audio or Internet protocol data over a licensed channel including one of AM, FM, VHF or UHV channels (8).

The process projects a keyboard pattern onto a first surface using the light projector (7). The camera 5 is used to capture images of user's digits on the keyboard pattern as the user types and digital images of the typing is decoded by the processor 1 to determine the character being typed (8). The processor 1 then displays typed character on a second surface with the light projector (9).

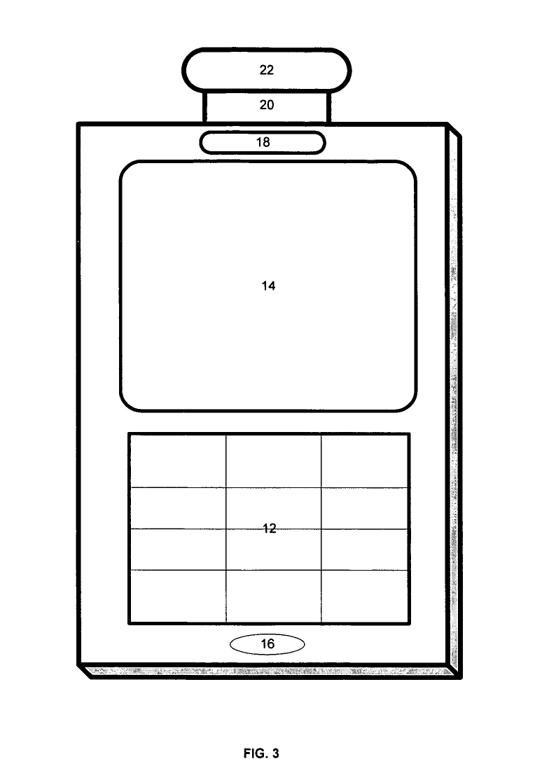

FIG. 3 shows one embodiment where the portable computer is implemented as a cellular phone 10. In FIG. 3, the cellular phone 10 has numeric keypad 12, a phone display 14, a microphone port 16, a speaker port 18. The phone 10 has dual projection heads mounted on the swivel base or rotatable support 20 to allow the heads to be swiveled by the user to adjust the display angle, for example. During operation, one head projects the user interface on a screen, while the other head displays a keyboard template onto a surface such as a table surface to provide the user with a virtual keyboard to “type” on. During operation, light from a light source internal to the phone 10 drives the heads. One head displays a screen for the user to view the output of processor 1, while the remaining head displays in an opposite direction the virtual keyboard using a predefined keyboard template. During operation, light from a light source internal to the phone 10 drives the heads. The head displays a screen for the user to view the output of processor 1, while the second head displays in an opposite direction the virtual keyboard using a predefined keyboard template. The first head projects the user interface on a first surface such as a display screen surface, while the second head displays a keyboard template onto a different surface such as a table surface to provide the user with a virtual keyboard to “type” on.

The light-projector can also be used as a camera flash unit. In this capacity, the camera samples the room lighting condition. When it detects a low light condition, the processor determines the amount of flash light needed. When the camera actually takes the picture, the light projector beams the required flash light to better illuminate the room and the subject.

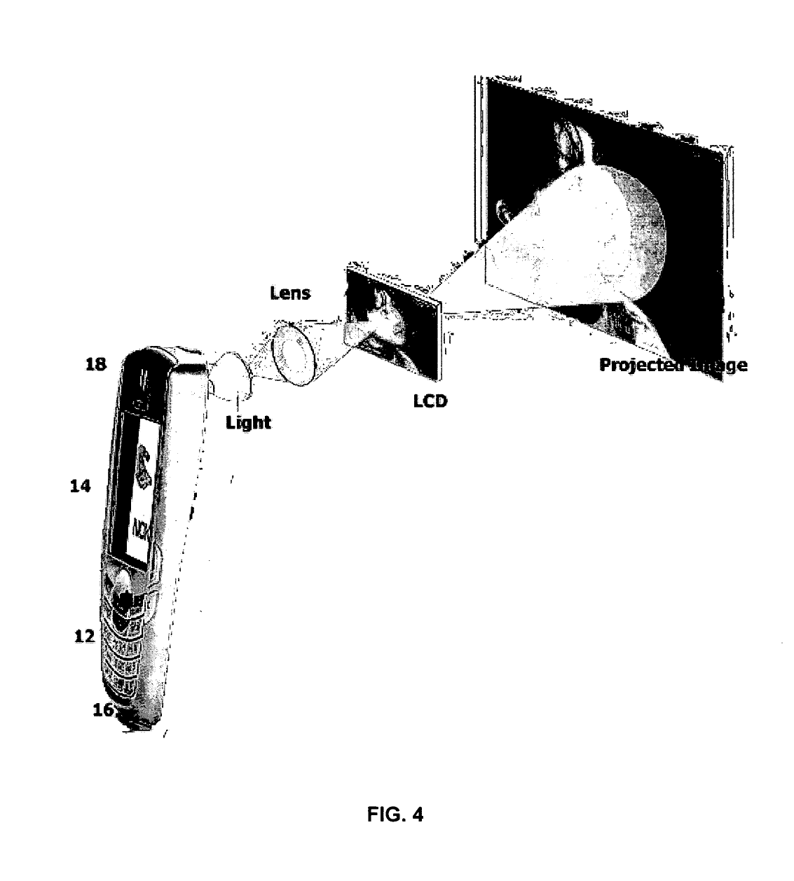

In one embodiment shown in FIG. 4, the phone 10 has a projection head that projects the user interface on a screen. During operation, light from a light source internal to the phone 10 drives the head that displays a screen for the user to view the output of processor 1. The head projects the user interface through a focusing lens and through an LCD to project the user interface rendered by the LCD onto a first surface such as a display screen surface.

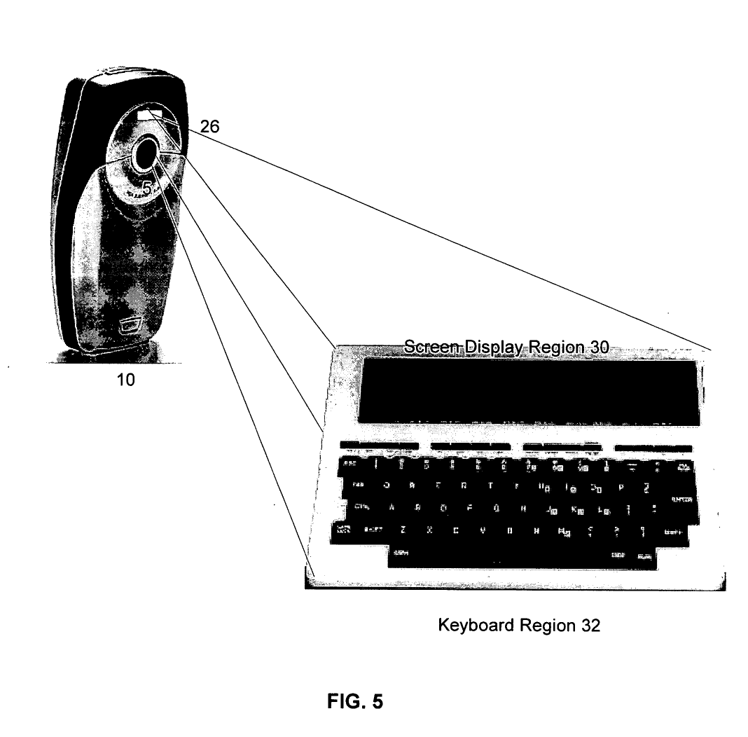

As shown in FIG. 5, in one embodiment, the head 26 displays a screen display region 30 in one part of the projected image and a keyboard region 32 in another part of the projected image. In this embodiment, the screen and keyboard are displayed on the same surface. During operation, the head 26 projects the user interface and the keyboard template onto the same surface such as a table surface to provide the user with a virtual keyboard to “type” on. Additionally, any part of the projected image can be “touch sensitive” in that when the user touches a particular area, the camera registers the touching and can respond to the selection as programmatically desired. This embodiment provides a virtual touch screen where the touch-sensitive panel has a plurality of unspecified key-input locations.

When user wishes to input some data on the touch-sensitive virtual touch screen, the user determines a specific angle between the cell phone to allow the image projector 24 or 26 to project a keyboard image onto a surface. The keyboard image projected on the surface includes an image of arrangement of the keypads for inputting numerals and symbols, images of pictures, letters and simple sentences in association with the keypads, including labels and/or specific functions of the keypads. The projected keyboard image is switched based on the mode of the input operation, such as a numeral, symbol or letter input mode. The user touches the location of a keypad in the projected image of the keyboard based on the label corresponding to a desired function. The surface of the touch-sensitive virtual touch screen for the projected image can have a color or surface treatment which allows the user to clearly observe the projected image. In an alternative, the touch-sensitive touch screen has a plurality of specified key-input locations such as obtained by printing the shapes of the keypads on the front surface. In this case, the keyboard image includes only a label projected on each specified location for indicating the function of the each specified location.

The virtual keyboard and display projected by the light projector are ideal for working with complex documents. Since these documents are typically provided in Word, Excel, PowerPoint, or Acrobat files, among others, the processor can also perform file conversion for one of: Outlook, Word, Excel, PowerPoint, Access, Acrobat, Photoshop, Visio, AutoCAD, among others.

Since high performance portable data devices can critical sensitive data, authentication enables the user to safely carry or transmit/receive sensitive data with minimal fear of compromising the data. The processor 1 can authenticate a user using one of: retina image captured by a camera, face image captured by the camera, and voice characteristics captured by a microphone.

In one embodiment, the processor 1 captures an image of the user's eye. The rounded eye is mapped from a round shape into a rectangular shape, and the rectangular shape is then compared against a prior mapped image of the retina.

In yet another embodiment, the user's face is captured and analyzed. Distinguishing features or landmarks are determined and then compared against prior stored facial data for authenticating the user. Examples of distinguishing land include the distance between ears, eyes, the size of the mouth, the shape of the mouth, the shape of the eyebrow, and any other distinguishing features such as scars and pimples, among others.

In yet another embodiment, the user's voice is recognized by a trained speaker dependent voice recognizer. Authentication is further enhanced by asking the user to dictate a verbal password.

To provide high security for bank transactions or credit transactions, a plurality of the above recognition techniques can be applied together. Hence, the system can perform retinal scan, facial scan, and voice scan to provide a high level of confidence that the person using the portable computing device is the real user.

Once digitized by the microphone and the camera, various algorithms can be applied to detect a pattern associated with a person. The signal is parameterized into features by a feature extractor. The output of the feature extractor is delivered to a sub-structure recognizer. A structure preselector receives the prospective sub-structures from the recognizer and consults a dictionary to generate structure candidates. A syntax checker receives the structure candidates and selects the best candidate as being representative of the person.

In one embodiment, a neural network is used to recognize each code structure in the codebook as the neural network is quite robust at recognizing code structure patterns. Once the speech or image features have been characterized, the speech or image recognizer then compares the input speech or image signals with the stored templates of the vocabulary known by the recognizer.

Data from the vector quantizer is presented to one or more recognition models, including an HMM model, a dynamic time warping model, a neural network, a fuzzy logic, or a template matcher, among others. These models may be used singly or in combination. The output from the models is presented to an initial N-gram generator which groups N-number of outputs together and generates a plurality of confusingly similar candidates as initial N-gram prospects. Next, an inner N-gram generator generates one or more N-grams from the next group of outputs and appends the inner trigrams to the outputs generated from the initial N-gram generator. The combined N-grams are indexed into a dictionary to determine the most likely candidates using a candidate preselector. The output from the candidate preselector is presented to a speech or image structure N-gram model or a speech or image grammar model, among others to select the most likely speech or image structure based on the occurrences of other speech or image structures nearby.

Dynamic programming obtains a relatively optimal time alignment between the speech or image structure to be recognized and the nodes of each speech or image model. In addition, since dynamic programming scores speech or image structures as a function of the fit between speech or image models and the speech or image signal over many frames, it usually gives the correct speech or image structure the best score, even if the speech or image structure has been slightly misspoken or obscured by background sound. This is important, because humans often mispronounce speech or image structures either by deleting or mispronouncing proper sounds, or by inserting sounds which do not belong.

In dynamic time warping, the input speech or image signal A, defined as the sampled time values A=a(1) . . . a(n), and the vocabulary candidate B, defined as the sampled time values B=b(1) . . . b(n), are matched up to minimize the discrepancy in each matched pair of samples. Computing the warping function can be viewed as the process of finding the minimum cost path from the beginning to the end of the speech or image structures, where the cost is a function of the discrepancy between the corresponding points of the two speech or image structures to be compared.

The warping function can be defined to be:
C=c(1), c(2), . . . , c(k), . . . c(K)

where each c is a pair of pointers to the samples being matched:
c(k)=[i(k), j(k)]

In this case, values for A are mapped into i, while B values are mapped into j. For each c(k), a cost function is computed between the paired samples. The cost function is defined to be:
d[c(k)]=(aᵢ₍ₖ₎−bⱼ₍ₖ₎)²

The warping function minimizes the overall cost function:

$$D ( C ) = {\sum }_{k = 1}^{K} d [ c ( k ) ]$$

subject to the constraints that the function must be monotonic
i(k)≧i(k−1) and j(k)≧j(k−1)
and that the endpoints of A and B must be aligned with each other, and that the function must not skip any points.

Dynamic programming considers all possible points within the permitted domain for each value of i. Because the best path from the current point to the next point is independent of what happens beyond that point. Thus, the total cost of [i(k), j(k)] is the cost of the point itself plus the cost of the minimum path to it. Preferably, the values of the predecessors can be kept in an M×N array, and the accumulated cost kept in a 2×N array to contain the accumulated costs of the immediately preceding column and the current column. However, this method requires significant computing resources.

The method of whole-speech or image structure template matching has been extended to deal with connected speech or image structure recognition. A two-pass dynamic programming algorithm to find a sequence of speech or image structure templates which best matches the whole input pattern. In the first pass, a score is generated which indicates the similarity between every template matched against every possible portion of the input pattern. In the second pass, the score is used to find the best sequence of templates corresponding to the whole input pattern.

Considered to be a generalization of dynamic programming, a hidden Markov model is used in the preferred embodiment to evaluate the probability of occurrence of a sequence of observations O(1), O(2), . . . O(t), . . . , O(T), where each observation O(t) may be either a discrete symbol under the VQ approach or a continuous vector. The sequence of observations may be modeled as a probabilistic function of an underlying Markov chain having state transitions that are not directly observable.

In the preferred embodiment, the Markov network is used to model a number of speech or image sub-structures. The transitions between states are represented by a transition matrix A=[a(i,j)]. Each a(i,j) term of the transition matrix is the probability of making a transition to state j given that the model is in state i. The output symbol probability of the model is represented by a set of functions B=[b(j) (O(t)], where the b(j) (O(t) term of the output symbol matrix is the probability of outputting observation O(t), given that the model is in state j. The first state is always constrained to be the initial state for the first time frame of the utterance, as only a prescribed set of left-to-right state transitions are possible. A predetermined final state is defined from which transitions to other states cannot occur.

Transitions are restricted to reentry of a state or entry to one of the next two states. Such transitions are defined in the model as transition probabilities. For example, a speech or image signal pattern currently having a frame of feature signals in state 2 has a probability of reentering state 2 of a(2,2), a probability a(2,3) of entering state 3 and a probability of a(2,4)=1−a(2,1)−a(2,2) of entering state 4. The probability a(2,l) of entering state 1 or the probability a(2,5) of entering state 5 is zero and the sum of the probabilities a(2,1) through a(2,5) is one. Although the preferred embodiment restricts the flow graphs to the present state or to the next two states, one skilled in the art can build an HMM model without any transition restrictions, although the sum of all the probabilities of transitioning from any state must still add up to one.

In each state of the model, the current feature frame may be identified with one of a set of predefined output symbols or may be labeled probabilistically. In this case, the output symbol probability b(j) O(t) corresponds to the probability assigned by the model that the feature frame symbol is O(t). The model arrangement is a matrix A=[a(i,j)] of transition probabilities and a technique of computing B=b(j) O(t), the feature frame symbol probability in state j.

The probability density of the feature vector series Y=y(1), . . . ,y(T) given the state series X=x(1), . . . , x(T) is
[Precise solution]

$${L}_{1} ( v ) = {\sum }_{x} P \{ Y , X \vert {λ}^{v} \}$$

[Approximate solution]

$${L}_{2} ( v ) = {max}_{x} [ P \{ Y , X \vert {λ}^{v} \} ]$$

[Log approximate solution]

$${L}_{3} ( v ) = {max}_{x} [ log P \{ Y , X \vert {λ}^{v} \} ]$$

The final recognition result v of the input speech or image signal x is given by:
where n is a positive integer.

$$v = {arg max}_{v} [ {L}_{n} ( v ) ]$$

The Markov model is formed for a reference pattern from a plurality of sequences of training patterns and the output symbol probabilities are multivariate Gaussian function probability densities. The speech or image signal traverses through the feature extractor. During learning, the resulting feature vector series is processed by a parameter estimator, whose output is provided to the hidden Markov model. The hidden Markov model is used to derive a set of reference pattern templates, each template representative of an identified pattern in a vocabulary set of reference speech or image sub-structure patterns. The Markov model reference templates are next utilized to classify a sequence of observations into one of the reference patterns based on the probability of generating the observations from each Markov model reference pattern template. During recognition, the unknown pattern can then be identified as the reference pattern with the highest probability in the likelihood calculator.

The HMM template has a number of states, each having a discrete value. However, because speech or image signal features may have a dynamic pattern in contrast to a single value. The addition of a neural network at the front end of the HMM in an embodiment provides the capability of representing states with dynamic values. The input layer of the neural network comprises input neurons. The outputs of the input layer are distributed to all neurons in the middle layer. Similarly, the outputs of the middle layer are distributed to all output states, which normally would be the output layer of the neuron. However, each output has transition probabilities to itself or to the next outputs, thus forming a modified HMM. Each state of the thus formed HMM is capable of responding to a particular dynamic signal, resulting in a more robust HMM. Alternatively, the neural network can be used alone without resorting to the transition probabilities of the HMM architecture.

Although the neural network, fuzzy logic, and HMM structures described above are software implementations, structures that provide the same functionality can be used. For instance, the neural network can be implemented as an array of adjustable resistance whose outputs are summed by an analog summer.

In another embodiment, music can be streamed to a cell phone from a music provider's web site. In one embodiment, music available from SIRIUS.COM or from XMRADIO.COM is streamed to the cell phone. For example, the Internet streaming music channel includes a wide assortment of music, from Pop, Hip Hop/R&B, Rock and Country to Jazz, Blues, Broadway, Electronic and Dance. It also includes channels dedicated to individual decades, such as '60s & '70s/Vinyl—top tracks from classic rock's formative years; '70s & '80s/Rewind—classic rock's 2nd generation, from the late '70s onward; '80s Glam/Hair Nation—vintage rock from the big hair '80s; '80s Alt/First Wave —alternative rock's pioneering artists and sounds; and Alt Rock/Alt Nation—the best alt-rock of the '90s and today.

Sirius and XM have their web streams in a Windows Media format and the player running on the cell phone then plays the streaming windows audio or video files. In one embodiment, software on a server (or a PC) retrieves music content from a server and sends the content through an Internet stream to a cell phone. The program logs into a content provider's site (600) and parses out the proper values from the online player in order to get the stream URL (602) and the stream URL is passed directly to a streaming player software (such as Windows Media Player) running on the cell phone (604).

In another embodiment, a computer is authenticated to the Sirius or XM radio server and software such as Super MP3 Recorder automatically chooses the best recording options and then saves the stream as an MP3 or WAV file. This download records streaming audio in many formats, including Windows Media Player, QuickTime, RealPlayer, and Flash. Yet other software such as Real MP3 Recorder can record from a variety of streaming formats, including RealPlayer, Windows Media Player, QuickTime, and streaming MP3. Alternatively, the computer runs software such as RipCast Streaming Audio Ripper to allow the user to connect to ShoutCast servers that play streaming audio in several different formats—and then save the audio to the mobile device as an MP3 file. This program also saves each song as a separate MP3, rather than saving them all as a single file.

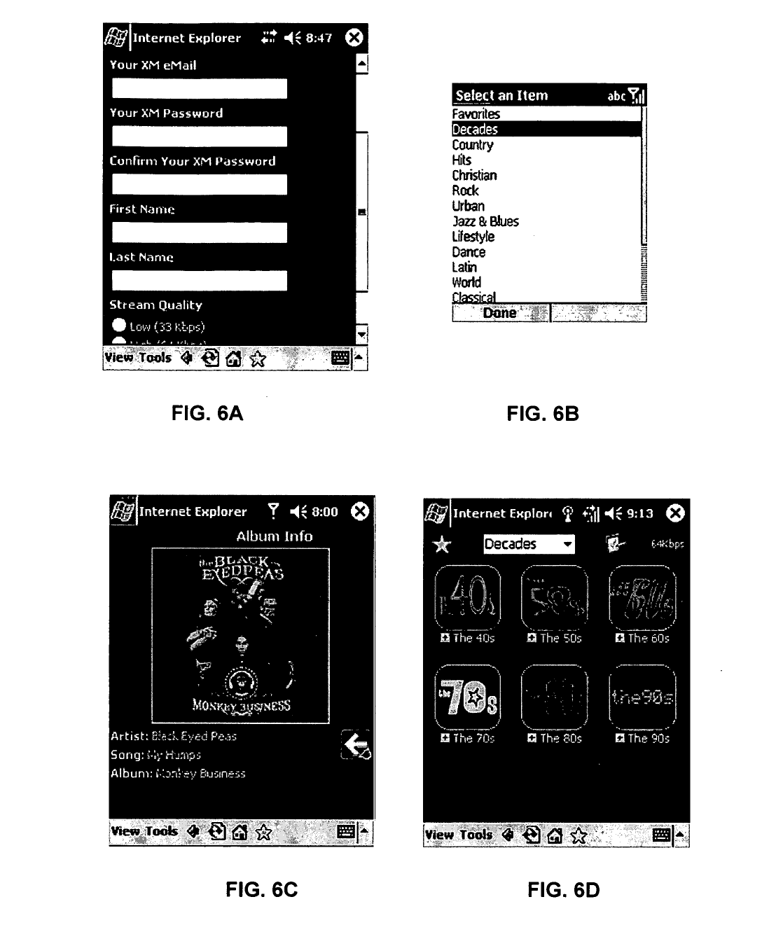

FIG. 6A shows an exemplary set-up screen running on a cell-phone. FIG. 6B shows an exemplary channel category selection user interface. FIG. 6C shows an exemplary album graphic display, while FIG. 6D shows an exemplary channel selection user interface.

In one embodiment, the system performs a search for a particular content. The search can be specified using SMS or specified using a WAP interface. Short Message Service (SMS) is a mechanism of delivery of short messages over the mobile networks and provides the ability to send and receive text messages to and from mobile telephones. SMS was created as part of the GSM Phase 1 standard. Each short message is up to 160 characters in length for Latin character messages. The 160 characters can comprise of words, numbers, or punctuation symbols. Short messages can also be non-text based such as binary. The Short Message Service is a store and forward service and messages are not sent directly to the recipient but through a network SMS Center. This enables messages to be delivered to the recipient if their phone is not switched on or if they are out of coverage at the time the message was sent—so called asynchronous messaging just like email. Confirmation of message delivery is another feature and means the sender can receive a return message notifying them whether the short message has been delivered or not. In some circumstances multiple short messages can be concatenated (stringing several short messages together.

In addition to SMS, Smart Messaging (from Nokia), EMS (Enhanced Messaging System) and MMS (Multimedia Messaging Service) have emerged. MMS adds images, text, audio clips and ultimately, video clips to SMS (Short Message Service/text messaging). Nokia created a proprietary extension to SMS called ‘Smart Messaging’ that is available on more recent Nokia phones. Smart messaging is used for services like Over The Air (OTA) service configuration, phone updates, picture messaging, operator logos etc. Smart Messaging is rendered over conventional SMS and does not need the operator to upgrade their infrastructure. SMS eventually will evolve toward MMS, which is accepted as a standard by the 3GPP standard. MMS enables the sending of messages with rich media such as sounds, pictures and eventually, even video. MMS itself is emerging in two phases, depending on the underlying bearer technology—the first phase being based on GPRS (2.5G) as a bearer, rather than 3G. This means that initially MMS will be very similar to a short PowerPoint presentation on a mobile phone (i.e. a series of “slides” featuring color graphics and sound). Once 3G is deployed, sophisticated features like streaming video can be introduced. The road from SMS to MMS involves an optional evolutionary path called EMS (Enhanced Messaging System). EMS is also a standard accepted by the 3GPP.

An exemplary process for communicating speech to a remote server for determining user commands is discussed next. The process captures user speech and converts user speech into one or more speech symbols. The speech symbols can be phonemes, diphones, triphones, syllables, and demisyllables. The symbols can be LPC cepstral coefficients or MEL cepstrum coding technique can be used as symbols as well. More details on the conversion of user speech into symbols are disclosed in U.S. Pat. No. 6,070,140 entitled “Speech Recognizer” by the inventor of the instant application, the content of which is incorporated by reference.

Next, the process determine a point of interest such as a music type (rap music, classical music, country music etc) or video type (western, mystery, romance, etc) (206). The process transmits the speech symbols and the point of interest over a wireless messaging channel to a search engine. The search engine can perform speech recognition and can optionally improve the recognition accuracy based on the point of interest as well as the user history. The system generates a search result based on the speech symbols. The user can scroll the search results and identify the entity that he/she would like to select. The voice search system can provide mobile access to virtually any type of live and on-demand audio content, including Internet-based streaming audio, radio, television or other audio source. Wireless users can listen to their favorite music, catch up on the latest news, or follow their favorite sports.

In addition to free text search, the system can also search predefined categories as well as undefined categories. For examples, the predefined categories can be categories of FIG. 6B, for example.

In one implementation, an audio alert can be sent to the cell phone. First, an SMS notification (text) announcing the alert is sent to the subscriber's cell phone. A connection is made to the live or on-demand audio stream. The user listens to the announcement as a live or on-demand stream. The system provides mobile phone users with access to live and on-demand streaming audio in categories such as music, news, sports, entertainment, religion and international programming. Users may listen to their favorite music, catch-up on latest news, or follow their sports team. The system creates opportunities for content providers and service providers, such as wireless carriers, with a growing content network and an existing and flourishing user base. Text-based or online offerings may be enhanced by streaming live and on-demand audio content to wireless users.

In another exemplary process in accordance with one embodiment of a mobile system such as a cell phone that can perform verbal mobile phone searches, the mobile system captures spoken speech from a user relating to a desired search term. A speech recognition engine recognizes the search term from the user's spoken request. The system then completes a search term query as needed. The system then sends the complete search term query to one or more search engines. The search engine can be a taxonomy search engine as described below. The system retrieves one or more search results from the search engine(s), and presents the search result(s) to the user. The user can listen to one of the search results.

In addition to SMS or MMS, the system can work with XHTML, Extensible Hypertext Markup Language, also known as WAP 2.0, or it can work with WML, Wireless Markup Language, also known as WAP 1.2. XHTML and WML are formats used to create Web pages that can be displayed in a mobile Web browser. This means that Web pages can be scaled down to fit the phone screen.

In one embodiment, the search engine is a taxonomy search engine (TSE). TSE is a web service approach to federating taxonomic databases such as Google or specialized databases from retailers, for example. The system takes the voice based query (expressed in phonemes, for example), converts the speech symbols into query text and the query is sent to a number of different databases, asking each one whether they contain results for that query. Each database has its on way of returning information about a topic, but the details are hidden from the user. TSE converts the speech symbols into a search query and looks up the query using a number of independent taxonomic databases. One embodiment uses a wrapper-mediator architecture, where each there is a wrapper for each external database. This wrapper converts the query into terms understood by the database and then translates the result into a standard format for a mediator which selects appropriate information to be used and formats the information for rendering on a mobile phone.

The user or producer can embed meta data into the video or music. Exemplary meta data for video or musical content such as CDs includes artist information such as the name and a list of albums available by that artist. Another meta data is album information for the title, creator and Track List. Track metadata describes one audio track and each track can have a title, track number, creator, and track ID. Other exemplary meta data includes the duration of a track in milliseconds. The meta data can describe the type of a release with possible values of: TypeAlbum, TypeSingle, TypeEP, TypeCompilation, TypeSoundtrack, TypeSpokenword, TypeInterview, TypeAudiobook, TypeLive, TypeRemix, TypeOther. The meta data can contain release status information with possible values of: StatusOfficial, StatusPromotion, StatusBootleg. Other meta data can be included as well.

The meta-data can be entered by the musician, the producer, the record company, or by a music listener or purchaser of the music. In one implementation, a content buyer (such as a video buyer of video content) can store his or her purchased or otherwise authorized content on the server in the buyer's own private directory that no one else can access. When uploading the multimedia files to the server, the buyer annotates the name of the files and other relevant information into a database on the server. Only the buyer can subsequently download or retrieve files he or she uploaded and thus content piracy is minimized. The meta data associated with the content is stored on the server and is searchable and accessible to all members of the community, thus facilitating searching of multimedia files for everyone.

In one implementation that enables every content buyer to upload his/her content into a private secured directory that cannot be shared with anyone else, the system prevents unauthorized distribution of content. In one implementation for music sharing that allows one user to access music stored by another user, the system pays royalty on behalf of its users and supports the webcasting of music according to the Digital Millennium Copyright Act, 17 U.S.C. 114. The system obtains a statutory license for the non-interactive streaming of sound recordings from Sound Exchange, the organization designated by the U.S. Copyright Office to collect and distribute statutory royalties to sound recording copyright owners and featured and non featured artists. The system is also licensed for all U.S. musical composition performance royalties through its licenses with ASCAP, BMI and SESAC. The system also ensures that any broadcast using the client software adheres to the sound recording performance complement as specified in the DMCA. Similar licensing arrangements are made to enable sharing of images and/or videos/movies.

The system is capable of indexing and summarizing images, music clips and/or videos. The system also identifies music clips or videos in a multimedia data stream and prepares a summary of each music video that includes relevant image, music or video information. The user can search the music using the verbal search system discussed above. Also, for game playing, the system can play the music or the micro-chunks of video in accordance with a search engine or a game engine instruction to provide better gaming enjoyment.

In one gaming embodiment, one or more accelerometers may be used to detect a scene change during a video game running within the mobile device. For example, the accelerometers can be used in a tilt-display control application where the user tilts the mobile phone to provide an input to the game. In another gaming embodiment, mobile games determine the current position of the mobile device and allow players to establish geofences around a building, city block or city, to protect their virtual assets. The mobile network such as the WiFi network or the cellular network allows players across the globe to form crews to work with or against one another. In another embodiment, digital camera enables users to take pictures of themselves and friends, and then map each digital photograph's looks into a character model in the game. Other augmented reality game can be played with position information as well.

“Computer readable media” can be any available media that can be accessed by client/server devices. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by client/server devices. Communication media typically embodies computer readable instructions, data structures, program modules or other data in a modulated data signal such as a carrier wave or other transport mechanism and includes any information delivery media.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method to play content from a satellite radio provider on a mobile phone, comprising:
authenticating the mobile phone with a satellite radio music server;
generating an internet protocol (IP) stream address for predetermined contents;
receiving data from the stream address over a cellular channel to the mobile phone; and
playing audio associated with the stream address on the mobile phone.

2. The method of claim 1, comprising performing a search to identify the predetermined content.

3. The method of claim 2, wherein the search comprises performing a taxonomy search for music.

4. The method of claim 2, wherein the predetermined contents are pre-selected by the satellite music server.

5. The method of claim 2, wherein the predetermined contents are selected by a user.

6. The method of claim 2, comprising selling content for downloading to the mobile phone.

7. The method of claim 2, wherein the stream address comprises one of: a URL address, an MMS address, an SMS address.

8. The method of claim 1, wherein the search is specified using one of: an SMS message, a WAP field.

9. The method of claim 1, comprising
projecting a keyboard pattern using a light projector;
capturing one or more images of a user's digits on the keyboard pattern with a camera;
decoding a character being typed on the keyboard pattern.

10. The method of claim 9, comprising projecting video onto a surface.

11. A cell phone capable of playing content from a satellite radio broadcaster, comprising:
a processor;
a wireless cellular radio coupled to the processor; and
code executing on the processor for authenticating the mobile phone; generating an Internet protocol stream universal resource locator (URL) for a predetermined content; and receiving data from the stream URL and playing the content associated with the stream URL on the mobile phone.

12. The cell phone of claim 11, comprising code to transmit audio or music from a satellite radio service to the mobile phone.

13. The cell phone of claim 11, comprising code to store audio or video data for subsequent playing.

14. The cell phone of claim 11, comprising code to display music album graphics.

15. The cell phone of claim 11, comprising code to receive a log-in and a password from the mobile phone.

16. The cell phone of claim 11, comprising code to preset a plurality of channels.

17. The cell phone of claim 11, comprising code to receive IP television (IPTV) data.

18. The cell phone of claim 11, comprising code to search for a predetermined content.

19. The cell phone of claim 11, comprising code to
project a keyboard pattern using a light projector;
capture one or more images of a user's digits on the keyboard pattern with a camera;
decode a character being typed on the keyboard pattern.

20. The cell phone of claim 19, comprising code to project video onto a surface.
